(19) United States
(12) Patent Application Publication
(10) Pub. No.: US 2017/0147723 A1
(43) Pub. Date: May 25, 2017

(54) METHOD OF SIMULATIVELY PREDICTING A METAL SOLIDIFICATION MICROSTRUCTURE FOR A CONTINUOUS CASTING PROCESS

(71) Applicant: METAL INDUSTRIES RESEARCH & DEVELOPMENT CENTRE, Kaohsiung (TW)

(72) Inventors: De-Chang TSAI, Kaohsiung (TW); Chen-Hsueh CHIANG, Kaohsiung (TW); Chien-Tzu CHENG, Kaohsiung (TW); Chun-Lin YEH, Kaohsiung (TW)

(21) Appl. No.: 15/333,427

(22) Filed: Oct. 25, 2016

(30) Foreign Application Priority Data
Nov. 20, 2015 (TW) 104138493

(51) Int. Cl. G06F 17/50; B22D 46/00; B22D 11/00

(52) U.S. Cl. CPC G06F 17/5009; B22D 11/00; B22D 46/00; G05B 17/02

(57) ABSTRACT

A method of simulatively predicting a metal solidification microstructure for a continuous casting process is provided, the method including steps of: providing a physical model simulation environment, providing a simulated temperature grid zone, providing an initial condition, calculating a temperature field, performing grain nucleation calculation and performing grain growth calculation. By means of the best metal microstructure, the best setting condition required by actual continuous casting is found, and a metal casting having the best microstructure is obtained.

### CROSS-REFERENCE TO RELATED APPLICATION

This application claims the benefit of Taiwan Patent Application No. 104138493, filed on Nov. 20, 2015, which is hereby incorporated by reference for all purposes as if fully set forth herein.

### BACKGROUND

Technical Field

The present disclosure relates to a metal solidification microstructure simulation prediction method, and particularly to a method of simulatively predicting a metal solidification microstructure for a continuous casting process.

Related Art

As a metal solidification microstructure is an important factor that affects the quality of a casting which is continuously casted, in a general metal solidification process, two methods are mostly employed for prediction control over grain structures, of which one is the traditional experiment method and the other is a computer simulation method; the computer simulation method can avoid the problem of consuming time and consuming materials, and thus in the continuous casting technical industry, the industries have actively developed a microstructure simulation prediction system to facilitate necessary experimental measurement and verification and quickly find out desired optimum process conditions.

In the existing related technical document that solves the foregoing problems, for example, Chinese Patent Publication Number CN102029368 A, discloses a method for on-line detecting solid and liquid fractions and a solidification end in a secondary cooling zone of continuous casting billet is disclosed. The method includes: (1) applying indirect excitation at a certain vibration frequency and amplitude to a casting billet in solidification of the secondary cooling zone by mounting a measuring device onto a casting machine; (2) transferring a sensor signal value fed back to a developed model analysis system; (3) obtaining solid and liquid fractions of the continuous casting billet in the secondary cooling zone in combination with a calculation formula of solid and liquid fractions of the casting billet in the secondary cooling zone; (4) obtaining an equivalent billet shell thickness d′ and a solidification end position prediction value L′ of the continuous casting billet in the secondary cooling zone on the basis of the above results; (5) obtaining a casting billet solidification coefficient K′ according to the equivalent billet shell thickness d′ and the square root law of casting billet solidification; (6) obtaining a composite solidification coefficient K according to weighted processing on the casting billet solidification coefficient K′ based on actual measurement and an empirical solidification coefficient K₀ of a casting steel type; and (7) transmitting the composite solidification coefficient K to a target parameter value calculating module and an algorithm correction module, to determine solid and liquid fractions and a solidification end position of the casting billet in the secondary cooling zone.

In the technical document (CN102029368 A), effects of a short equipment modification cycle, a low investment cost and more convenient later-stage maintenance are provided, the solidification end position of the casting billet can be determined under a constant drawing speed steady-state casting condition, and solid and liquid fractions and a solidification end position of the casting billet in different positions can be given more accurately and quantitatively, but only after results are directly detected on-line can a condition parameter of the continuous casting process be adjusted to the best process condition, and before the best process condition is found, it is bound to spend material money, and is not in line with economic benefits.

In view of this, it is necessary to provide a method of simulatively predicting a metal solidification microstructure for a continuous casting process, to find out the best setting condition required by actual continuous casting process and obtain a metal casting having the best microstructure.

### SUMMARY

A main objective of the present disclosure is to provide a method of simulatively predicting a metal solidification microstructure for a continuous casting process, to find out the best setting condition required by actual continuous casting and obtain a metal casting having the best microstructure.

To achieve the above objective, the present disclosure provides a method of simulatively predicting a metal solidification microstructure for a continuous casting process, the method including: providing a physical model simulation environment, providing a simulated temperature grid zone, providing an initial condition, calculating a temperature field, performing grain nucleation calculation and performing grain growth calculation. By means of the best metal microstructure, the best setting condition required by actual continuous casting is found, and a metal casting having the best microstructure is obtained.

The physical model simulation environment includes: a simulated metal casting; a simulated drawing rod, for drawing the simulated metal casting; and at least one simulation tool, for cooling the simulated metal casting.

The simulated temperature grid zone includes: a dynamic grid zone, comprising multiple dynamic grids each of which is used for correspondingly storing a first simulated temperature of the simulated metal casting and the simulated drawing rod; and a static grid zone, comprising multiple static grids each of which is used for correspondingly storing a second simulated temperature of each simulation tool.

The initial condition includes an interface heat conduction coefficient between the simulated metal casting and each simulation tool and between the simulation tools.

The step of calculating a temperature field is adapted for calculating and updating the first and second simulated temperatures according to the interface heat conduction coefficient, a drawing time of the simulated drawing rod, and the first and second simulated temperatures of the dynamic grids and the static grids, to form the temperature field corresponding to the simulated temperature grid zone.

The step of performing grain nucleation calculation is adapted for judging whether the first simulated temperature of each dynamic grid is lower than a melting point of the simulated metal casting, and calculating a microstructure grain density of the simulated metal casting corresponding to the dynamic grid.

The step of performing grain growth calculation is adapted for calculating a grain growth length in the dynamic grid according to the microstructure grain density.

The present disclosure is characterized in that: the method of simulatively predicting a metal solidification microstructure for a continuous casting process is adapted for simulating distribution of actual temperatures of a metal casting in a continuous casting process, to facilitate metal solidification microstructure simulation prediction.

In order to make the foregoing and other objectives, features and advantages of the present disclosure more evident, detailed description is provided below with reference to the accompanying drawings.

### BRIEF DESCRIPTION OF THE DRAWINGS

FIG. 1 is a flow diagram of a method of simulatively predicting a metal solidification microstructure for a continuous casting process according to an embodiment of the present disclosure;

FIG. 2 is a schematic diagram of a physical model simulation environment according to an embodiment of the present disclosure;

FIG. 3 is a schematic diagram of a simulated temperature grid zone according to an embodiment of the present disclosure;

FIG. 4 is a schematic diagram of interfaces of a physical model simulation environment according to an embodiment of the present disclosure;

FIG. 5 is a schematic diagram of a dynamic temperature field according to an embodiment of the present disclosure;

FIG. 6 is a comparison diagram of drawing speed vs. drawing time according to an embodiment of the present disclosure;

FIG. 7 is a flow diagram of a method of simulatively predicting a metal solidification microstructure for a continuous casting process according to another embodiment of the present disclosure;

FIG. 8a is a phase diagram of distribution of axial grain sizes of simulated continuous casting process according to an embodiment of the present disclosure;

FIG. 8b is a phase diagram of distribution of axial grain sizes of actual continuous casting process according to an embodiment of the present disclosure;

FIG. 9a is a phase diagram of distribution of radial grain sizes of simulated continuous casting process according to an embodiment of the present disclosure; and

FIG. 9b is a phase diagram of distribution of radial grain sizes of actual continuous casting process according to an embodiment of the present disclosure.

### DETAILED DESCRIPTION

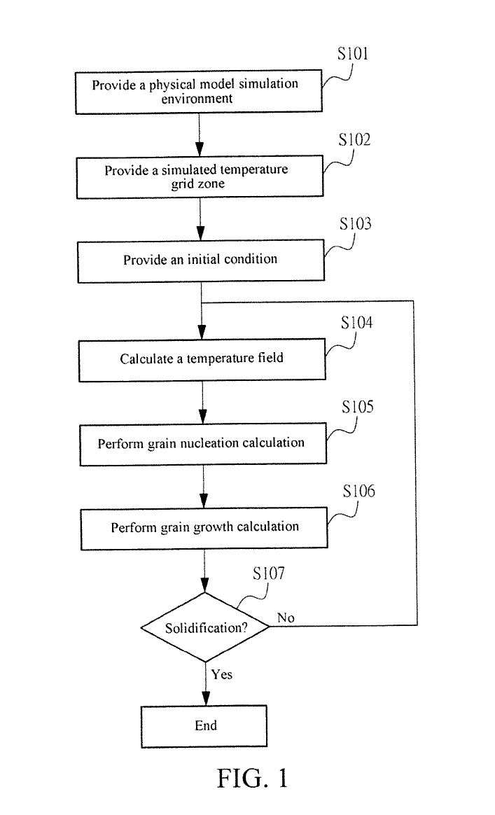

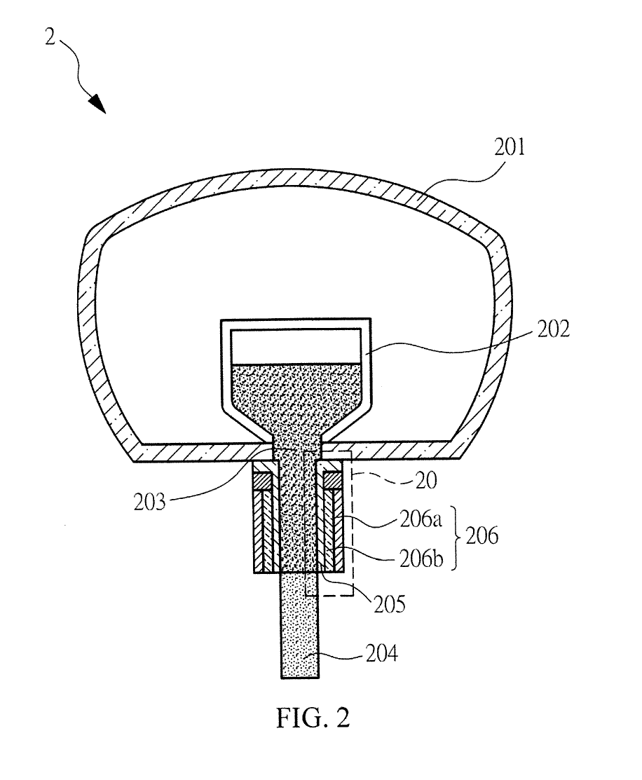

FIG. 1 is a flow diagram of a method of simulatively predicting a metal solidification microstructure for a continuous casting process according to an embodiment of the present disclosure, and FIG. 2 is a schematic diagram of a physical model simulation environment according to an embodiment of the present disclosure.

Referring to FIG. 1, the method of simulatively predicting a metal solidification microstructure for a continuous casting process according to an embodiment of the present disclosure includes step S101: providing a physical model simulation environment, step S102: providing a simulated temperature grid zone, step S103: providing an initial condition, step S104: calculating a temperature field, step S105: performing grain nucleation calculation, and step S106: performing grain growth calculation.

Referring to FIG. 2 in combination with FIG. 1, in step S101, a physical model simulation environment is provided. The physical model simulation environment 2 includes a simulated metal casting 203, a simulated drawing rod 204 and at least one simulation tool. The simulated metal casting 203 is selected from pure metal or metal alloy, the metal alloy being selected from one of brass, aluminum bronze, silicon bronze, phosphor bronze, nickel silver copper and silver copper. In this embodiment, that the simulated metal casting 203 is metal copper is taken as an example. The simulated drawing rod 204 is used for drawing the simulated metal casting 203. The simulation tool can include a vacuum cavity 201, a graphite crucible 202, a simulated graphite die 205 and a simulated cooling system 206. The simulated cooling system 206 includes a cooling copper sleeve 206b and cooling water 206a, wherein the simulated graphite die 205 and the simulated cooling system 206 are used for cooling the simulated metal casting 203.

As the physical model simulation environment 2 is a cylindrical model with axial symmetry, in simulation, a half (e.g., a left half part or a right half part) of a part to be simulated in the physical model simulation environment 2 can be taken as a solidification microstructure simulation prediction region, for simplifying numerical calculation. For example, in FIG. 2, the simulation region 20 is taken as a solidification microstructure simulation prediction region, whereby the simulation region 20 include the simulated metal casting 203, the simulated drawing rod 204, the simulated graphite die 205 and the simulated cooling system 206.

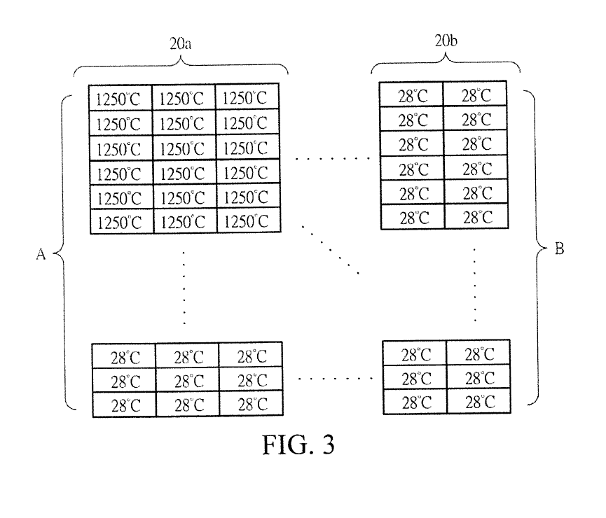

Referring to FIG. 3 in combination with FIG. 1 and FIG. 2, in step S102, a simulated temperature grid zone is provided. The simulated temperature grid zone includes: a dynamic grid zone A and a static grid zone B.

The dynamic grid zone 20a includes multiple dynamic grids A, each of which is used for correspondingly storing a first simulated temperature of the simulated metal casting 203 and the simulated drawing rod 204. In this embodiment, the first simulated temperature (i.e., simulated initial temperature) of the simulated metal casting 203 which is high-temperature liquid molten metal is set as a casting temperature T₀T=T≅1250° C., and the first simulated temperature (i.e., simulated initial temperature) of the simulated drawing rod 204 at the beginning is set as the room temperature which is about 28° C.

The static grid zone 20b includes multiple static grids B, each of which is used for correspondingly storing a second simulated temperature of each simulation tool. In detail, each of the static grids 20b is used to respectively store second simulated temperatures of the simulated graphite die 205 and the simulated cooling system 206 (including a cooling copper sleeve 206b and cooling water 206a), and the second simulated temperatures at the beginning (i.e., simulated initial temperature) are all set as the room temperature which is about 28° C.

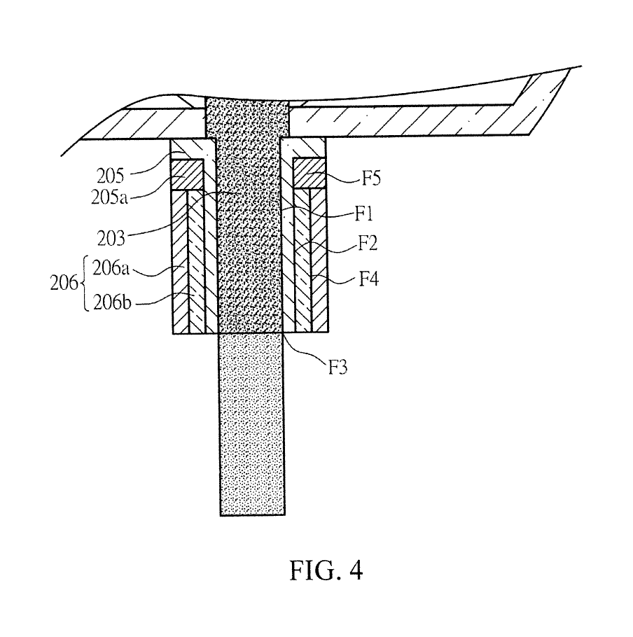

Referring to FIG. 4 with reference to FIG. 1, in step S103, an initial condition is provided. The initial condition includes an interface heat conduction coefficient between the simulated metal casting and each simulation tool and between the simulation tools. For example:

Interface F1 is an interface between the simulated metal casting 203 and the simulated graphite die 205. With contraction and expansion of solidification of the simulated metal casting 203, an air gap is present between a surface of the simulated metal casting 203 and the simulated graphite die 205, so that heat transfer efficiency between the simulated metal casting 203 and the simulated graphite die 205 is evidently reduced; to embody such a change, the interface heat conduction coefficient of the interface F1 is used as a temperature function, and a composite heat conduction coefficient λ_{gap} (e.g., the following formula 1-1) is used as the interface heat conduction coefficient of the interface F1, for processing heat transfer calculation of boundaries thereof. λ_{cu} and λ_{g} are the solidified shell of the simulated metal casting 203 and the heat conduction coefficient of the simulated graphite die 205, respectively, and hᵢ is the interface heat conduction coefficient between the solidified shell of the simulated metal casting 203 and the simulated graphite die 205 (W·m⁻²·K⁻¹).

$${λ}_{gap} = \frac{1}{\frac{{λ}_{cu} + {λ}_{g}}{2 {λ}_{cu} {λ}_{g}} + \frac{1}{Δ {rh}_{i}}} \\ {λ}_{cu} = \{ \begin{matrix}393 + 13.5 {T}_{cu} - 7.5 {T}_{cu}^{2} , {T}_{cu} < 600 \\ 260 + 174 {T}_{cu} - 68 {T}_{cu}^{2} , {T}_{cu} ≧ 600\end{matrix} \\ {λ}_{g} = \{ \begin{matrix}79.6 - 2.8 * {10}^{- 2} {T}_{g} - 1.2 * {10}^{- 5} {T}_{g}^{2} , {T}_{g} < 845 \\ 78.8 - 4.2 * {10}^{- 2} {T}_{g} + 6.6 {T}_{g}^{2} , {T}_{g} ≧ 845\end{matrix} \qquad ( formula 1 \text{-} 1 )$$

The r is the x-axis direction distance, the T_{cu} is the first simulated temperature of the simulated metal casting 203, and the T_{g} is the first simulated temperature of the simulated graphite die 205.

Interface F2 is a junction surface of an outer surface of the simulated graphite die 205 and an inner surface of the cooling copper sleeve 206b; due to their close contact, it may be regarded that there is no thermal contact resistance (ideal contact: hᵢ→∞); therefore, an interface heat conduction coefficient of the junction surface of the outer surface of the simulated graphite die 205 and the inner surface of the cooling copper sleeve 206b is used as a temperature function, and a composite heat conduction coefficient λ_{c} (e.g., the following formula 1-2) is used as the interface heat conduction coefficient of the interface F2, wherein λ_{g} and λ_{cu} are heat conduction coefficients of the simulated graphite die 205 and the cooling copper sleeve 206b, respectively.

$${λ}_{c} = \frac{1}{\frac{{λ}_{cu} + {λ}_{g}}{2 {λ}_{cu} {λ}_{g}}} \qquad ( formula 1 \text{-} 2 )$$

Interface F3 is a blending mode of air natural convection heat transfer and radiation heat transfer, which processes boundary heat transfer calculation thereof by using an equivalent heat transfer coefficient λₑ=30(W·m⁻²·K⁻¹) (i.e., the interface heat conduction coefficient of the interface F3).

Interface F4 is a heat exchange interface between the cooling copper sleeve 206b and the cooling water 206a of the cooling system 206, an belongs to a convective heat transfer boundary, and its convective heat transfer coefficient λ_{wa}=24.13ω^{0.55}(1−7.5*10⁻³ T_{wa}) (i.e., the interface heat conduction coefficient of the interface F4). The ω is water flow density (L·m⁻²·s⁻¹), and the ω is a sectional area of the cooling water volume divided by the inner diameter of the cooling copper sleeve 206b. The T_{wa} is the cooling water temperature (° C.).

Interface F5 is an adiabatic boundary; as the simulated graphite die 205 in the position is coated with a layer of heat-insulating asbestos material 205a around, mainly for avoiding that high-temperature molten metal seeps from the top to damage the cooling copper sleeve 206b and other devices, and thus the interface F5 is regarded as an adiabatic boundary condition.

$$\frac{\partial T}{\partial r} = 0$$

That is, the interface F5 does not affect the heat conduction in the x-axis direction.

According to the above initial condition, in step S104, a temperature field is calculated. The temperature field calculates and updates the first and second simulated temperatures according to the interface heat conduction coefficients of the interfaces F1-F5, the drawing time of the simulated drawing rod 204 and the first and second simulated temperatures of each dynamic grid A and each static grid B, to form the temperature field corresponding to the simulated temperature grid zone.

In detail, the first and second simulated temperatures of each dynamic grid A and each static grid B can change with the drawing time, and the updated first and second simulated temperatures of each dynamic grid A and each static grid B can be related to the first simulated temperatures and/or the second simulated temperatures of the dynamic grids and/or static dynamics grids in the neighborhood of thereof (e.g., above, below, left and right).

For example, the following formula 1-3 is a calculation formula of the updated first and second simulated temperatures of the dynamic grid and the static grid at the next drawing time:

$${T}_{n , m}^{p + 1} = {T}_{n , m}^{p} + \frac{Δ t}{ρ C} [ {T}_{1} + {T}_{2} + {T}_{3} + {T}_{4} ] + \frac{Δ h \cdot Δ t}{ρ C} \\ n = i , i \pm 1 , i \pm 2 , … , i \pm k \\ m = j , j \pm 1 , j \pm 2 , … , j \pm k \qquad ( formula 1 \text{-} 3 )$$

The Δt is a drawing time interval. The Δh=205 (kj·kg⁻¹) (which is latent heat). The ρ is density, the C is specific heat, for example, when the first simulated temperature of the dynamic grid of the simulated metal casting 203 is calculated, ρ=ρ_{cu}=7900 kg·m⁻³, and C=C_{cu}=0.389−1.5*10⁻² T_{n,m}^{p}+1.1*10⁻² T_{n,m}^{p}^{₂}, and when he first simulated temperature of the static grid of the simulated graphite die 205 is calculated, ρ=ρ_{g}=1667 kg·m⁻³, and C=C_{g} (e.g., the following formula 1-4). The k depends on the number of the dynamic grid and the static grid. The T_{n,m}^{p} is the first simulated temperature or the second simulated temperature of a certain dynamic grid (e.g., A(i, j)) or static grid (e.g., B(i, j)) at the pervious drawing time. The T_{n,m}^{p+1} is the updated first simulated temperature or second simulated temperature of the dynamic grid A(i, j) or the static grid B(i, j).

$${C}_{g} = \{ \begin{matrix}3.1 + 1.4 * {10}^{- 3} {T}_{n , m}^{p} , {T}_{n , m}^{p} < 676 \\ 1.9 + 2.5 * {10}^{- 4} {T}_{n , m}^{p} , {T}_{n , m}^{p} ≧ 676\end{matrix} \qquad ( formula 1 \text{-} 4 )$$

The

$${T}_{1} = {λ}_{1} \frac{2 n Δ {rT}_{n + 1 , m}^{p} + Δ {r}^{2} {T}_{n + 1 , m}^{p} - {T}_{n , m}^{p}}{Δ {r}^{2} \cdot 2 n Δ r}$$

is a temperature contribution value provided by a dynamic grid (e.g., A(i+1, j)) on the right of the dynamic grid A(i, j).

The

$${T}_{2} = {λ}_{2} \frac{2 n Δ {rT}_{n - 1 , m}^{p} + Δ {r}^{2} {T}_{n + 1 , m}^{p} - {T}_{n , m}^{p}}{Δ {r}^{2} \cdot 2 n Δ r}$$

is a temperature contribution value provided by a dynamic grid (e.g., A(i−1, j)) on the left of the dynamic grid A(i, j).

The

$${T}_{3} = {λ}_{3} \frac{{T}_{n , m + 1}^{p} - {T}_{n , m}^{p}}{Δ z}$$

is a temperature contribution value provided by a dynamic grid (e.g., A(i, j+1)) above the dynamic grid A(i, j).

The

$${T}_{4} = {λ}_{4} \frac{{T}_{n , m - 1}^{p} - {T}_{n , m}^{p}}{Δ z}$$

is a temperature contribution value provided by a dynamic grid (e.g., A(i, j−1)) below the dynamic grid A(i, j).

Also, when the dynamic grid A(i, j) and the dynamic grid A(i+1, j) on the right thereof are located on the interface F1, F2, F3 or F4, the λ₁ can be equal to λ_{gap}, λ_{c}, λₑ or λ_{wa} respectively. By parity of reasoning, when the dynamic grid A(i, j) and the dynamic grid A(i−1, j) on the left thereof are located on the interface F1, F2, F3 or F4, the λ₂ can be equal to λ_{gap}, λ_{c}, λₑ or λ_{wa} respectively. When the dynamic grid A(i, j) and the dynamic grid A(i, j+1) thereabove are located on the interface F1, F2, F3 or F4, the λ₃ can be equal to λ_{gap}, λ_{c}, λₑ or λ_{wa} respectively. When the dynamic grid A(i, j) and the dynamic grid A(i, j−1) therebelow are located on the interface F1, F2, F3 or F4, the λ₄ can be equal to λ_{gap}, λ_{c}, λₑ or λ_{wa} respectively.

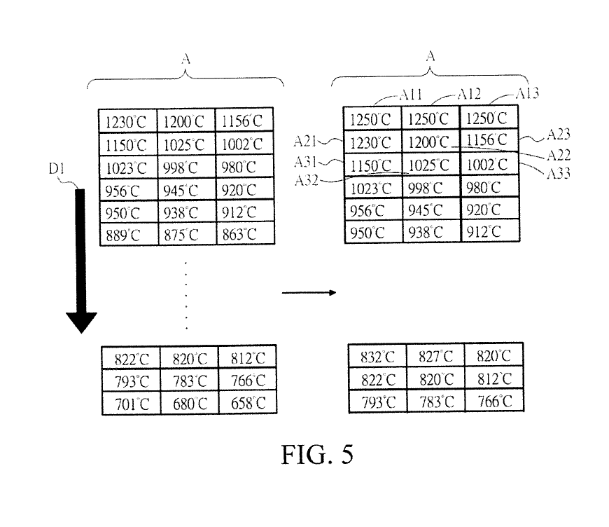

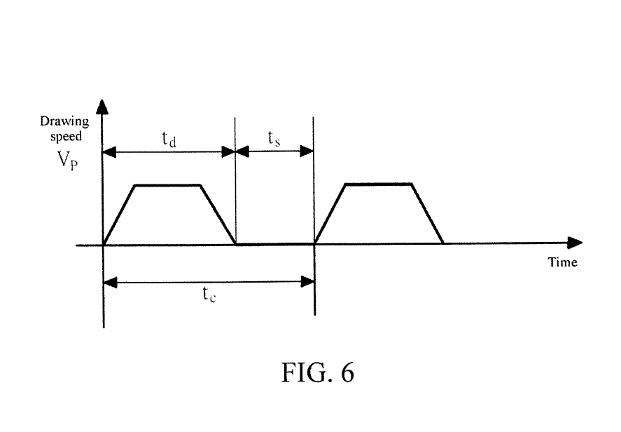

Referring to FIG. 5 and FIG. 6 together with FIG. 1, the simulated drawing rod 204 of this embodiment has a drawing direction D1 (as shown in FIG. 5), a drawing cycle t_{c} and a drawing speed Vₚ (i.e., casting speed) (as shown in FIG. 6), and each time the drawing time exceeds the drawing cycle t_{c}, the first simulated temperature of the dynamic grid A can replace the first simulated temperature of the dynamic grid A in a corresponding different position according to the drawing direction D1, the drawing cycle t_{c} and the drawing speed Vₚ, making the dynamic grid zone 20a form a dynamic temperature field.

In detail, the drawing cycle t_{c} includes a continuous drawing time t_{d} and a stay time tₛ, it can be known from the continuous drawing time t_{d} and the stay time tₛ that a motion state of the simulated metal casting 203 changes from motion to stillness or from stillness to motion, and after the drawing time passes through the continuous drawing time t_{d} and the stay time tₛ and is greater than the drawing cycle t_{c}, it is determined that the simulated drawing rod 204 draws the simulated metal casting 203, thus affecting the change of the first simulated temperature of the dynamic grid. That is to say, suppose that there are 120 dynamic grids in a longitudinal direction, a longitudinal length of each dynamic grid is 0.5 mm, a drawing speed (continuous casting speed) is 150 mm/min, the drawing cycle t_{c} is 0.4 s, and the continuous drawing time t^{d} is 0.3 s; at this point, the simulated drawing rod 204 can be controlled to draw the simulated metal casting 203 every 0.4 s, and a displacement length of the simulated metal casting is equal to the length of moving one dynamic grid longitudinally.

For example, referring to FIG. 5 again, when a drawing cycle t_{c} goes by, temperature values of the dynamic grids A11, A12 and A13 can replace those of the dynamic grids A21, A22 and A23 respectively, the temperature values of the dynamic grids A21, A22 and A23 can replace those of the dynamic grids A31, A32 and A33 respectively, and so on. Thus, the dynamic grid zone 20a can form a dynamic temperature field by means of the drawing cycle t_{c}, for simulating distribution of actual temperatures of a metal casting in a continuous casting process, to facilitate metal solidification microstructure simulation prediction.

When the first simulated temperatures of certain dynamic networks (e.g., A11, A12, A13) are not replaced according to the drawing direction D1, the simulated initial temperature (e.g., 1250 [symbol] °C.) of the sin point.

In step S105, grain nucleation calculation is performed. The grain nucleation calculation is used for judging whether the first simulated temperature of each dynamic grid A is lower than a melting point (e.g., a melting point of metal copper is at about 1085 [symbol] ° C. under an atmospheric pressure) of the simulated metal casting 203, and calculating a microstructure grain density of the simulated metal casting 203 corresponding to the dynamic grid A.

In detail, a calculation formula of the microstructure grain density is as follows:

$$ln ( Δ n ) - ln ( Δ T ) = ln {n}_{ma x} - ln \sqrt{2 π} - ln ( Δ {T}_{σ} ) - \frac{( Δ T - Δ \overline{T} )}{2 Δ {T}_{σ}^{2}} \qquad ( formula 1 \text{-} 5 )$$

The nₘₐₓ=8.0*10¹⁰ (m⁻³) is the maximum grain density. The ΔT̅=1.0 (° C. ) is an average grain undercooling degree. The ΔT_{σ}=0.1 (° C.) is standard deviation of grain distribution. In this embodiment, the ΔT is a undercooling degree, the ΔT can be equal to a temperature undercooling degree ΔTₜ, and the ΔTₜ is a difference between the previous first simulated temperature (e.g., T _{n,m}^{p}) of the dynamic grid A and the updated first simulated temperature (e.g., T_{n,m}^{p+1}), that is, ΔTₜ=T_{n,m}^{p}−T_{n,m}^{p+1}.

It can be known according to the formula 1-5 that, at different drawing times, a certain number of microstructure grain densities Δn can be present for the temperature undercooling degree ΔTₜ of each dynamic grid A.

Next, in step S106, grain growth calculation is performed, which calculates a grain growth length l(tₙ) in the dynamic grid A according to the microstructure grain density Δn . A calculation formula of the grain growth length l(tₙ) is as follows:

$$l ( {t}_{n} ) = {\sum }_{n = 1}^{N} {V}_{n} \{ Δ T ( t ) \} \cdot Δ t \qquad ( formula 1 \text{-} 6 )$$

The N is the number of cycles. The Δt is a drawing time interval. The speed is Vₙ=αΔT²+βΔT³, wherein α=1.1*10⁻⁵, and β=3.0*10⁻⁶.

Therefore, through the above steps S101-S106, the present disclosure can perform simulation prediction on a continuously cast metal solidification microstructure, for finding out the best setting of conditions, for example, casting conditions such as a continuous casting speed, a casting temperature and cooling volume, required by actual continuous casting, and obtaining a metal casting having an optimized microstructure.

Referring to FIG. 1 again, in this embodiment, the method of simulatively predicting a metal solidification microstructure for a continuous casting process further includes step S107 of solidification judgment, wherein, when the grain growth length l(tₙ) is equal to or greater than a length (e.g., 0.5 mm) of each dynamic grid A, the calculation of the temperature field, the grain nucleation calculation step is stopped. In detail, when each dynamic grid A is filled with grains, it indicates that the simulated metal casting 203 has been solidified, and the calculation of the temperature field, the grain nucleation calculation and the grain growth calculation can be stopped.

For example, whether each dynamic grid A is filled with grains can be judged by calculating cellular solid fractions according to the following calculation formula by using a cellular automaton method:

$${f}_{s}^{i} ( {t}_{n} ) = \frac{{l}_{v}^{i} ( {t}_{n} )}{{L}_{v}^{i}} \qquad ( formula 1 \text{-} 7 )$$

i is a liquid cell. The v is a solid cell. The lⁱᵥ is a grain growth length of the liquid cell i in a time of tₙ. The Lⁱᵥ is a distance from the solid cell v to the liquid cell i, if the liquid cell i is located in one of the six nearest neighbor positions, Lⁱᵥ=dx (dx is the size of one cell), if the liquid cell i is located in one of the twelve next nearest neighbor positions, Lⁱᵥ=\sqrt{2}dx, and if the liquid cell i is located in one of the eight distant neighbor top corner positions, Lⁱᵥ=\sqrt{3}dx. When the solid fraction is fₛⁱ(tₙ)≧1, the state of the liquid cell i changes from a liquid state to a solid state, and the calculation of the temperature field, the grain nucleation calculation and the grain growth calculation can be stopped; on the contrary, when the solid fraction is fₛⁱ(tₙ)<1, the state of the liquid cell i is still a liquid state, and the calculation of the temperature field, the grain nucleation calculation and the grain growth calculation are continued.

Therefore, whether the simulated metal casting corresponding to each dynamic grid has changed from a liquid state to a solid state can be calculated according to step S107, which only requires making a microstructure at once.

In an embodiment, within a drawing time of a certain drawing cycle t_{c}, when a difference between a first simulated temperature (e.g., T_{n,m}^{p+1}) of a current time and a first simulated temperature (e.g., T_{n,m}^{p}) of a previous time of each dynamic grid A is less than or equal to a threshold (e.g., 10⁻³), the temperature field is a steady temperature field. Therefore, during simulation, the steps of grain nucleation calculation and grain growth calculation can be performed after the dynamic temperature field is calculated to the steady temperature field, for reducing the computing amount of the simulation, which can save the configuration cost of the simulation device relatively.

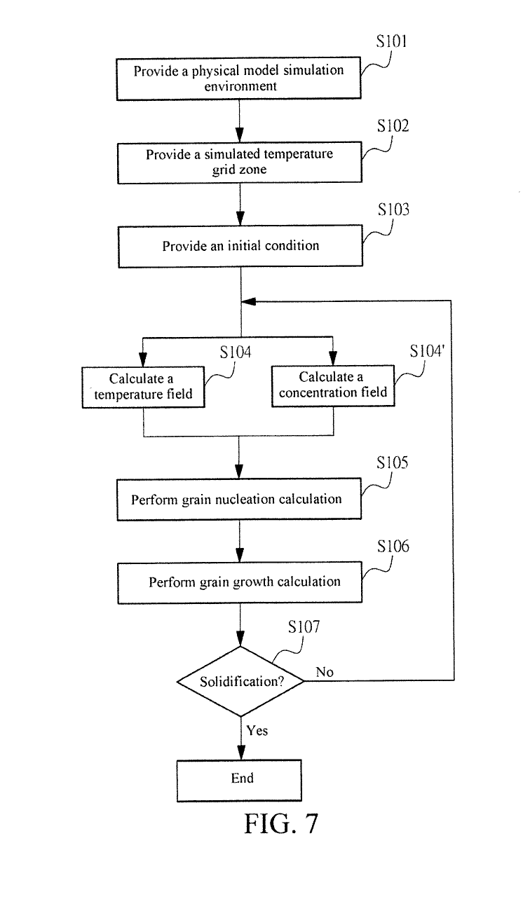

In another embodiment, when the simulated metal casting 203 is a metal alloy (e.g., a brass alloy Cu30Zn), the method of simulatively predicting a metal solidification microstructure for a continuous casting process further includes step S104′ (refer to FIG. 7): calculating a concentration field, making each dynamic grid further used for storing a simulated concentration and calculating and updating the simulated concentration according to the drawing time of the simulation draw rod and the simulated concentration of each dynamic grid. In this embodiment, a simulated initial temperature of the first simulated temperature stored by the dynamic grid can be set as 0.3 wt %.

In detail, the simulated concentration of each dynamic grid A can change with the drawing time, and the updated simulated concentration of each dynamic grid A is related to the simulated concentration of the dynamic grid A in the neighborhood thereof (e.g., above, below, left and right).

For example, the following is a calculation formula of the updated simulated concentration of the dynamic grid at the next drawing time:

Calculation of a liquid metal concentration field:

C_{n,m}^{p+1}=C_{n,m}^{p}+ΔtDₗ[C₁+C₂+C₃+C₄]+C_{n,m}^{p}(1−k′)(fₛ_{_{n,m}}^{p+1}−fₛ_{_{n,m}}^{p}) (formula 1-8)

n=i,i±1, i±2, . . . , i±k

m=j,j±1, j±2, . . . , j±k

The Dₗ is a liquid solute diffusion coefficient (the Dₗ=2.04*10⁻⁹ in terms of the brass alloy). The Dₛ is a solid solute diffusion coefficient (the Dₛ=1.59*10⁻¹² in terms of the brass alloy). The k depends on the number of the dynamic grid and the static grid. The k′ is a balance coefficient (the k′=0.83 in terms of the brass alloy). The C_{n,m}^{p} is a first simulated temperature of a certain dynamic grid (e.g., A(i, j)) at the previous drawing time. The C_{n,m}^{p+1} is the updated first simulated temperature of the dynamic grid A(i, j).

The

$${C}_{1} = \frac{{C}_{n + 1 , m}^{p} - {C}_{n , m}^{p}}{Δ {r}^{2}}$$

is a concentration contribution value provided by a dynamic grid (e.g., A(i+1, j)) on the right of the dynamic grid A(i, j).

The

$${C}_{2} = \frac{{C}_{n - 1 , m}^{p} - {C}_{n , m}^{p}}{Δ {r}^{2}}$$

is a concentration contribution value provided by a dynamic grid (e.g., A(i−1, j)) on the left of the dynamic grid A(i, j).

The

$${C}_{3} = \frac{{C}_{n , m + 1}^{p} - {C}_{n , m}^{p}}{Δ {z}^{2}}$$

is a concentration contribution value provided by a dynamic grid (e.g., A(i, j+1)) above the dynamic grid A(i, j).

The

$${C}_{4} = \frac{{C}_{n , m - 1}^{p} - {C}_{n , m}^{p}}{Δ {z}^{2}}$$

is a concentration contribution value provided by a dynamic grid (e.g., A(i, j−1)) below the dynamic grid A(i, j).

Calculation of a solid metal concentration field:

C_{n,m}^{p+1}=C_{n,m}^{p}+tDₛ[C₁′+C₂′+C₃′+C₄′] (formula 1-9)

The

$${C}_{1}^{′} = \frac{{C}_{n + 1 , m}^{p} - {C}_{n , m}^{p}}{Δ {r}^{2}}$$

is a concentration contribution value provided by a dynamic grid (e.g., A(i+1, j)) on the right of the dynamic grid A(i, j).

The

$${C}_{2}^{′} = \frac{{C}_{n - 1 , m}^{p} - {C}_{n , m}^{p}}{Δ {r}^{2}}$$

is a concentration contribution value provided by a dynamic grid (e.g., A(i−1, j)) on the left of the dynamic grid A(i, j).

The

$${C}_{3}^{′} = \frac{{C}_{n , m + 1}^{p} - {C}_{n , m}^{p}}{Δ {z}^{2}}$$

is a concentration contribution value provided by a dynamic grid (e.g., A(i, j+1)) above the dynamic grid A(i, j).

The

$${C}_{4}^{′} = \frac{{C}_{n , m - 1}^{p} - {C}_{n , m}^{p}}{Δ {z}^{2}}$$

is a concentration contribution value provided by a dynamic grid (e.g., A(i, j−1)) below the dynamic grid A(i, j).

Calculation of a solid metal concentration field: Cₛ*=k′Cₗ*

The * indicates the position of a solid liquid interface.

In this embodiment, a calculation formula of the undercooling degree of the concentration is as follows:

ΔT_{c}=m(C₀−Cₗ*) (formula 1-9)

The m is a liquidus slope. The C₀ is an initial concentration of the brass alloy, that is, the simulated initial concentration (0.3) stored by each dynamic grid. The Cₗ* refers to a liquid concentration at a crystal tip.

Referring to FIG. 5 and FIG. 6 together with FIG. 1, as the dynamic temperature field stated above, in this embodiment, each time the drawing time of the simulated drawing rod 204 exceeds the drawing cycle t_{c}, the simulated concentration of each dynamic grid A can replace the simulated concentration of the dynamic grid A in a corresponding different position according to the drawing direction D1, the drawing cycle t_{c} and the drawing speed Vₚ, making the dynamic grid zone 20a form a dynamic concentration field. In addition, when the simulated concentration of one dynamic grid is not replaced, a simulated initial concentration (e.g., 0.3 wt %) of the simulated metal casting can replace the simulated concentration. The simulation of the dynamic concentration field is substantially the same as that of the dynamic temperature field, which is not repeated herein.

In this embodiment, due to the addition of the calculation of the concentration field, the undercooling degree ΔT also includes the concentration undercooling degree ΔT_{c} in addition to including the temperature undercooling degree ΔTₜ, that is:

ΔT=ΔTₜ+ΔT_{c} (formula 1-10)

A new total undercooling degree ΔT (shown in formula 1-10) can be obtained by integrating the temperature undercooling degree and the concentration undercooling degree. Therefore, if the total undercooling degree ΔT of the formula 1-10 is substituted into the formula 1-5 and the formula 1-6, more accurate microstructure grain density and grain growth length can be calculated, which is conductive to simulation accuracy.

Implementation Test:

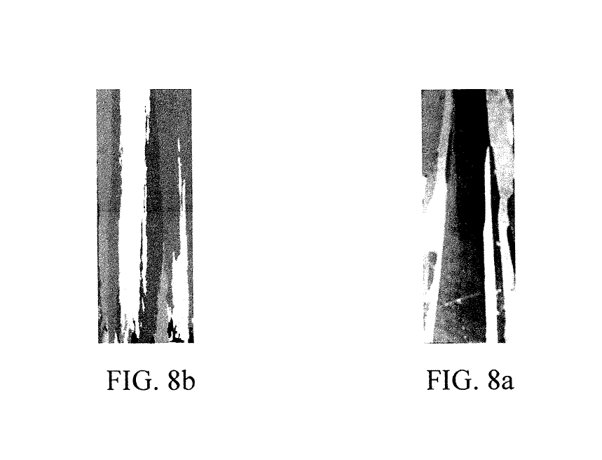

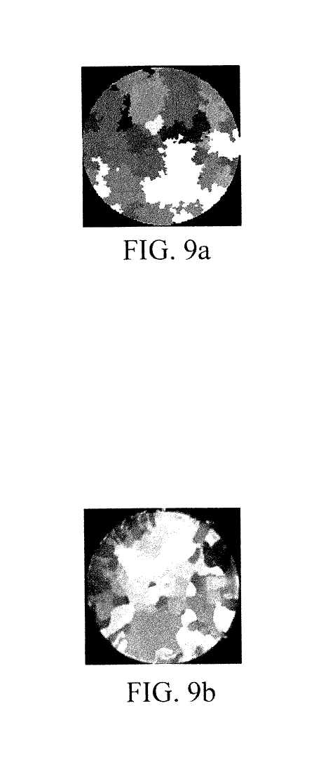

According to the method of simulatively predicting a metal solidification microstructure for a continuous casting process of the present disclosure, an axial grain simulation diagram (as shown in FIG. 8a) and a radial grain simulation diagram (as shown in FIG. 9a) having greater grain size distribution simulation obtained have the following best process parameter condition:

a continuous casting speed: 150 mm/min;

a casting temperature: 1200° C.; and

cooling flow: 15 L/min.

the phase diagram of distribution of axial grain sizes (as shown in FIG. 8b) and the phase diagram of distribution of radial grain sizes (as shown in FIG. 9b) obtained in actual continuous casting process according to the process parameter condition are substantially the same as the simulated results of the simulated continuous casting process according to the best parameter condition.

The above merely describes implementations or embodiments of technical means employed by the present disclosure to solve the technical problems, which are not intended to limit the patent implementation scope of the present disclosure. Equivalent changes and modifications in line with the meaning of the patent scope of the present disclosure or made according to the scope of the disclosure patent are all encompassed in the patent scope of the present disclosure.

What is claimed is:

1. A method of simulatively predicting a metal solidification microstructure for a continuous casting process, comprising steps of:
providing a physical model simulation environment, the physical model simulation environment comprising:
a simulated metal casting;
a simulated drawing rod, for drawing the simulated metal casting; and
at least one simulation tool, for cooling the simulated metal casting;
providing a simulated temperature grid zone, the simulated temperature grid zone comprising:
a dynamic grid zone, comprising multiple dynamic grids each of which is used for correspondingly storing a first simulated temperature of the simulated metal casting and the simulated drawing rod; and
a static grid zone, comprising multiple static grids each of which is used for correspondingly storing a second simulated temperature of each simulation tool;
providing an initial condition, the initial condition comprising an interface heat conduction coefficient between the simulated metal casting and each simulation tool and between the simulation tools;
calculating a temperature field, for calculating and updating the first and second simulated temperatures according to the interface heat conduction coefficient, a drawing time of the simulated drawing rod, and the first and second simulated temperatures of the dynamic grids and the static grids, to form the temperature field corresponding to the simulated temperature grid zone;
performing grain nucleation calculation, for judging whether the first simulated temperature of each dynamic grid is lower than a melting point of the simulated metal casting, and calculating a microstructure grain density of the simulated metal casting corresponding to the dynamic grid; and
performing grain growth calculation, for calculating a grain growth length in the dynamic grid according to the microstructure grain density.

2. The method of simulatively predicting a metal solidification microstructure for a continuous casting process according to claim 1, wherein the simulated drawing rod has a drawing direction, a drawing cycle and a drawing speed, and each time the drawing time exceeds the drawing cycle, the first simulated temperature of the dynamic grid replaces the first simulated temperature of the dynamic grid in a corresponding different position according to the drawing direction, the drawing cycle and the drawing speed, making the dynamic grid zone form a dynamic temperature field.

3. The method of simulatively predicting a metal solidification microstructure for a continuous casting process according to claim 2, wherein, when a difference between a temperature of a current time and a temperature of a previous time of each dynamic grid is less than or equal to a threshold, the temperature field is a steady temperature field, for judging whether to perform the grain nucleation calculation step and reducing the computing amount of the grain nucleation calculation and the grain growth calculation.

4. The method of simulatively predicting a metal solidification microstructure for a continuous casting process according to claim 2, wherein
when the first simulated temperature of each dynamic grid is not replaced, a simulated initial temperature of the simulated metal casting replaces the first simulated temperature.

5. The method of simulatively predicting a metal solidification microstructure for a continuous casting process according to claim 1, further comprising a step of solidification judgment, wherein
when the grain growth length is equal to or greater than a length of each dynamic grid, the calculation of the temperature field, the grain nucleation calculation and the grain growth calculation are stopped; and
when the grain growth length is less than the length of the dynamic grid, the calculation of the temperature field, the grain nucleation calculation and the grain growth calculation are continued.

6. The method of simulatively predicting a metal solidification microstructure for a continuous casting process according to claim 1, wherein the simulated metal casting is selected from pure metal or metal alloy, the metal alloy being selected from one of brass, aluminum bronze, silicon bronze, phosphor bronze, nickel silver copper and silver copper.

7. The method of simulatively predicting a metal solidification microstructure for a continuous casting process according to claim 6, when the simulated metal casting is the metal alloy, the method further comprising a step of calculating a concentration field, making each dynamic grid further used for storing a simulated concentration and calculating and updating the simulated concentration according to the drawing time of the simulation draw rod and the simulated concentration of each dynamic grid.

8. The method of simulatively predicting a metal solidification microstructure for a continuous casting process according to claim 7, wherein the simulation draw rod has a drawing direction, a drawing cycle and a drawing speed, and each time the drawing time exceeds the drawing cycle, the simulated concentration of each dynamic grid replaces the simulated concentration of the dynamic grid in a corresponding different position according to the drawing direction, the drawing cycle and the drawing speed, making the dynamic grid zone form a dynamic concentration field.

9. The method of simulatively predicting a metal solidification microstructure for a continuous casting process according to claim 8, wherein:
when the simulated concentration of one dynamic grid is not replaced, a simulated initial concentration of the simulated metal casting replaces the simulated concentration.
